(19) United States
(12) Patent Application Publication
(10) Pub. No.: US 2014/0313081 A1
(43) Pub. Date: Oct. 23, 2014

(54) Multiple Beam Formation for RF Chip-Based Antenna Array

(71) Applicant: Nokia Siemens Networks Oy, (US)

(72) Inventors: Jun Tan, Lake Zurich, IL (US); Thomas Kovarik, Grayslake, IL (US); Rapeepat Ratasuk, Hoffman Estates, IL (US)

(73) Assignee: Nokia Siemens Networks Oy, Espoo (FI)

(21) Appl. No.: 13/864,567

(22) Filed: Apr. 17, 2013

(51) Int. Cl. H01Q 3/00

(52) U.S. Cl. CPC H01Q 3/00
USPC 342/377; 342/368

(57) ABSTRACT

A method for selectively performing beam formation using a RF chip-based antenna array is described. The method includes determining whether to use a plurality of antenna arrays in one or more common carrier substrates in either a single group or a plurality of groups. The method also includes, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group. Apparatus and computer readable media are also described.

### TECHNICAL FIELD

The exemplary and non-limiting embodiments relate generally to wireless communication systems, methods, devices and computer programs and, more specifically, relate to multiple beam formation using a RF chip-based antenna array.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

An antenna architecture may require a large array of elements, such as an N×M array, that exceeds a practical die size. Thus, the array may be composed of multiple smaller arrays, such as where each smaller array is a 2×2, 3×3 or 4×4 array for example, that are placed on a common carrier substrate. What is needed is a technique to use the multiple smaller arrays for selectively performing beam formation.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method for selectively performing beam formation using a RF chip-based antenna array. The method includes determining whether to use a plurality of antenna arrays in one or more common carrier substrates in either a single group or a plurality of groups. The method also includes, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group.

In a further aspect thereof an exemplary embodiment provides an apparatus for selectively performing beam formation using a RF chip-based antenna array. The apparatus includes at least one processor and at least one memory storing computer program code. The at least one memory and the computer program code are configured to, with the at least one processor, cause the apparatus to perform actions. The actions include determining whether to use a plurality of antenna arrays in one or more common carrier substrates in either a single group or a plurality of groups. The actions also include, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group.

In another aspect thereof an exemplary embodiment provides a computer readable medium for selectively performing beam formation using a RF chip-based antenna array. The computer readable medium is tangibly encoded with a computer program executable by a processor to perform actions. The actions include determining whether to use a plurality of antenna arrays in one or more common carrier substrates in either a single group or a plurality of groups. The actions also include, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group.

In a further aspect thereof an exemplary embodiment provides an apparatus for selectively performing beam formation using a RF chip-based antenna array. The apparatus includes means for determining whether to use a plurality of antenna arrays in one or more common carrier substrates in either a single group or a plurality of groups. The apparatus also includes means for providing a single coupling factor to all antenna arrays in the plurality of antenna arrays in response to determining to use the plurality of antenna arrays in a single group, and means for providing, for each group in the plurality of groups, a group-specific coupling factor to each antenna array in the group in response to determining to use the plurality of antenna arrays in a plurality of groups.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 is a logic flow diagram that illustrates the operation of an exemplary method, and a result of execution of computer program instructions embodied on a computer readable memory, in accordance with various exemplary embodiments.

FIG. 2 shows an exemplary embodiment of a receive (RX) radio frequency (RF) chain 200 in accordance with an exemplary embodiment.

FIG. 3 shows an exemplary embodiment of a transmit (TX) RF chain in accordance with an exemplary embodiment.

FIG. 4 shows another exemplary embodiment of a RX RF chain in accordance with an exemplary embodiment.

FIG. 5 shows another exemplary embodiment of a TX RF chain in accordance with an exemplary embodiment.

FIG. 6 illustrates a radio frequency integrated circuit (RFIC) structure in accordance with an exemplary embodiment.

FIG. 7 illustrates an omni-directional coverage structure in accordance with an exemplary embodiment.

FIG. 8 illustrates another exemplary embodiment of a RFIC in accordance with an exemplary embodiment.

FIG. 9 shows an exemplary embodiment of a RFIC being used for formation of a single beam.

FIG. 10 shows another exemplary embodiment of the RFIC in FIG. 9 being used for formation of two beams.

FIG. 11 displays a beam power/direction graph in accordance with an exemplary embodiment.

FIG. 12 shows a simplified block diagram of exemplary electronic devices that are suitable for use in practicing various exemplary embodiments.

### DETAILED DESCRIPTION

Various exemplary embodiments provide a method, apparatus and computer program(s) to selectively performing beam formation using a RF chip-based antenna array.

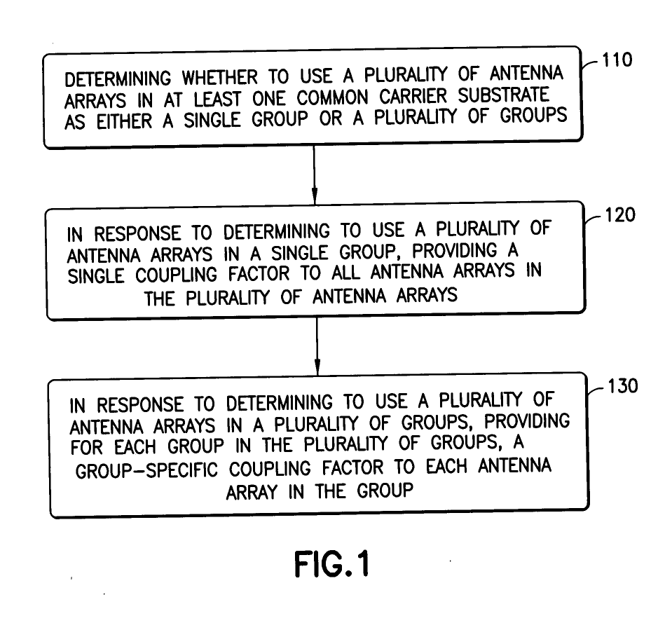

FIG. 1 is a logic flow diagram that illustrates the operation of a method, and a result of execution of computer program instructions, in accordance with exemplary embodiments. In accordance with these exemplary embodiments a method performs, at Block 110, a step of determining whether to use a plurality of antenna arrays in a common carrier substrate in either a single group or a plurality of groups. In response to determining to use the plurality of antenna arrays in a single group, the method performs a step of providing a single coupling factor to all antenna arrays in the plurality of antenna arrays at Block 120. In response to determining to use the plurality of antenna arrays in a plurality of groups, for each group in the plurality of groups the method performs a step of providing a group-specific coupling factor to each antenna array in the group.

The various blocks shown in FIG. 1 may be viewed as method steps, and/or as operations that result from operation of computer program code, and/or as a plurality of coupled logic circuit elements constructed to carry out the associated function(s).

A radio frequency integrated circuit (RFIC) may have three different distribution layers, or networks—antenna, local oscillator (LO) and digital baseband. These distribution networks may be all located on a common carrier substrate, such as a LTCC or HTCC carrier plate with multiple metalized layers. The RFIC die can be electrically and mechanically bonded to this carrier plate. Power distribution may also be accommodated via this distribution network.

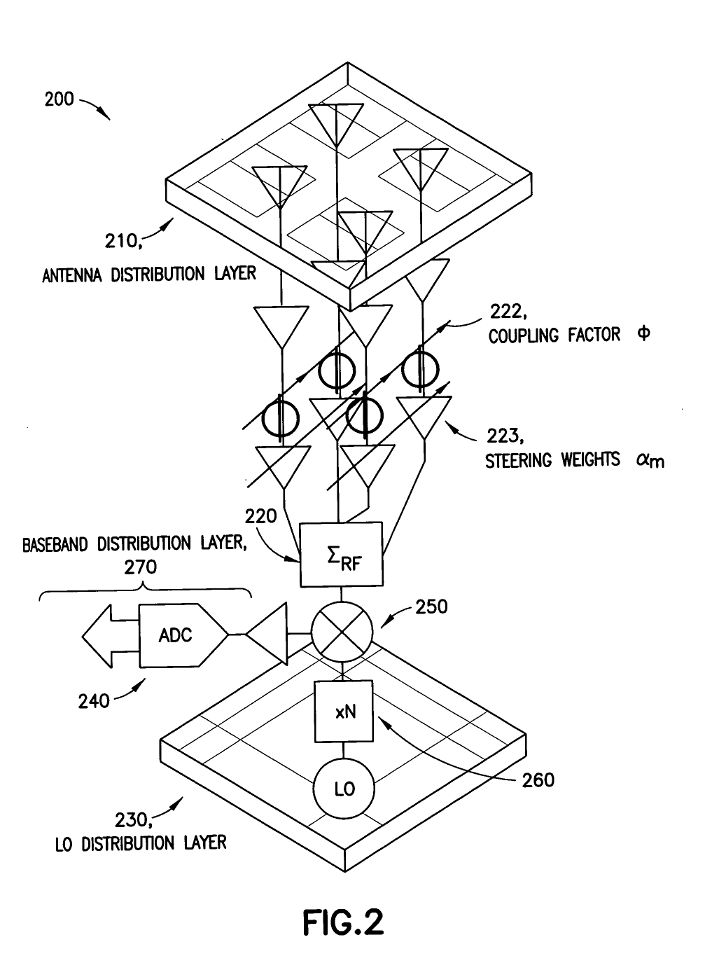

FIG. 2 shows an exemplary embodiment of a receive (RX) radio frequency (RF) chain 200 in accordance with an exemplary embodiment. The RX RF chain 200 includes various layers: an antenna distribution layer 210, a LO distribution layer 230 and a baseband distribution layer 270. Signals received at the antenna distribution layer 210 are processed using a coupling factor, φ, 222 and steering weights, αₘ, 223 and then summed in RF combiner 220.

The LO distribution layer 230 provides an oscillating signal to the multiplier 260 which is mixed with the output of the RF combiner 220 in mixer 250. The resulting signal is provided to the baseband distribution layer 270. In this non-limiting example, the baseband distribution layer 270 includes an on-chip analog/digital converter (ADC) 240.

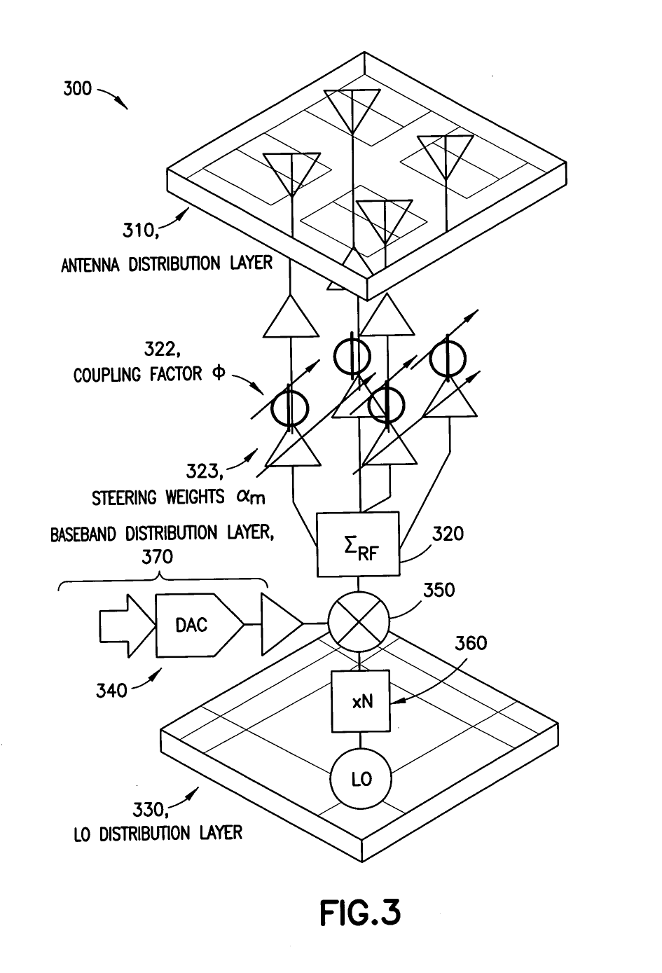

FIG. 3 shows an exemplary embodiment of a transmit (TX) RF chain 300 in accordance with an exemplary embodiment. Similar to the RX RF chain 200 of FIG. 2, the TX RF chain 300 includes an antenna distribution layer 310, a LO distribution layer 330 and a baseband distribution layer 370.

A signal is received in the baseband distribution layer 370 and is processed by the digital/analog converter (DAC) 340. The results are then mixed in mixer 350 with an oscillating signal from the LO distribution layer 330 and multiplier 360. The output of the mixer 350 is then separated into individual streams in the RF combiner 320. These streams are processed using a coupling factor, φ, 322 and steering weights, αₘ, 323 before being passed to the antenna distribution layer 310 for transmission.

Data converters, particularly the ADC, may consume considerable power, especially when operating at a high conversion rate. An alternative method to digital baseband distribution is to route analog IF or baseband signals between the RFIC die to a central IF/baseband IC that will phase combine the signals in the analog domain and use a single ADC and DAC.

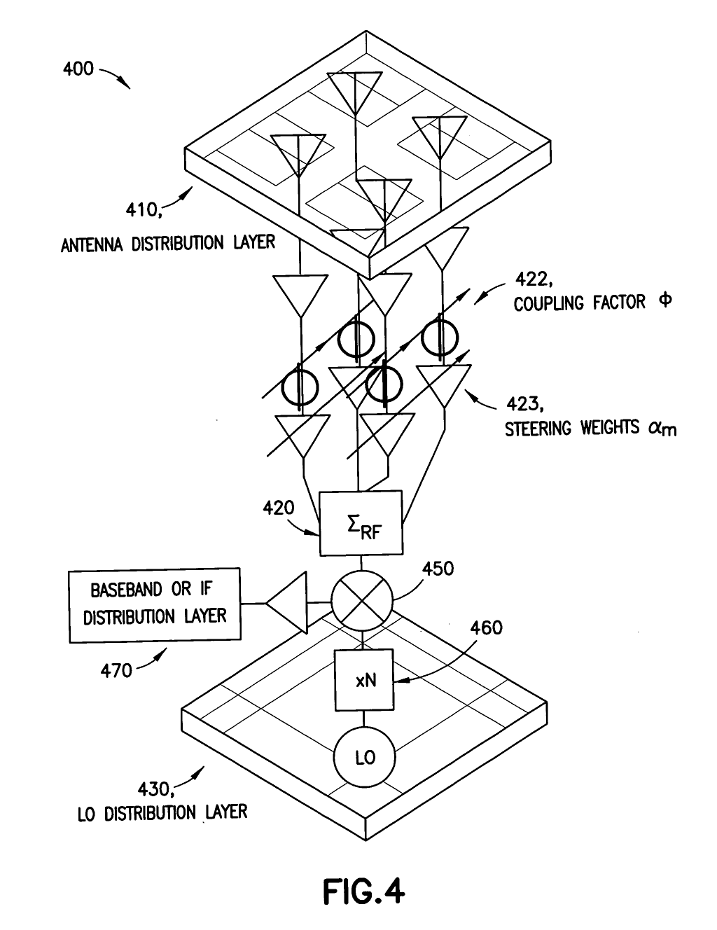

FIG. 4 shows another exemplary embodiment of a RX RF chain 400 in accordance with an exemplary embodiment. This RX RF chain 400 uses off-chip baseband processing. The RX RF chain 400 includes various layers: an antenna distribution layer 410, a LO distribution layer 430 and a baseband distribution layer 470. Signals received at the antenna distribution layer 410 are processed using a coupling factor, φ, 422 and steering weights, αₘ, 423 and then summed in RF combiner 420. The LO distribution layer 430 provides an oscillating signal to the multiplier 460 which is mixed with the output of the RF combiner 420 in mixer 450. The resulting signal is provided to the baseband distribution layer 470. In this non-limiting example, the baseband distribution layer 270 processing is processed off-chip, for example, by a main processor (not shown).

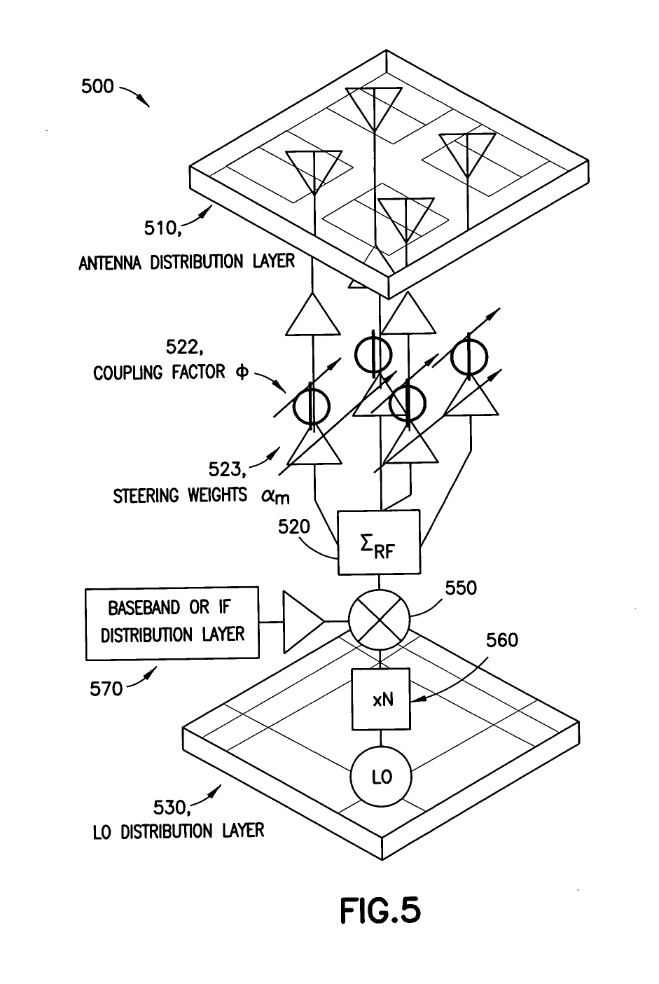

FIG. 5 shows another exemplary embodiment of a TX RF chain 500 in accordance with an exemplary embodiment. Similar to the RX RF chain 400 of FIG. 4, the TX RF chain 500 includes an antenna distribution layer 510, a LO distribution layer 530 and a baseband distribution layer 570. A signal is received from the baseband distribution layer 570 (which may be located off-chip, for example, in a central processing unit (not shown)) and then mixed in mixer 550 with an oscillating signal from the LO distribution layer 530 and multiplier 560. The output of the mixer 550 is then separated into individual streams in the RF combiner 520. These streams are processed using a coupling factor, φ, 522 and steering weights, αₘ, 523 before being passed to the antenna distribution layer 510 for transmission.

FIGS. 2-5 show Tx and Rx chains. An alternative architecture may utilize bidirectional elements, such as bidirectional amplifiers, passive phase networks, etc. that enable smaller integrated circuit (IC) geometries for time division duplexing (TDD) applications in which one of the Tx or the Rx chain is active but not both at the same time.

A combined distribution layer and carrier plate/body can have multiple RFIC die bonded to it and provide distribution to a large array of elements. By designing the physical antenna elements appropriately, dual-polarized solutions can be provided. Alternatively the elements can be single polarization and the entire unit simply rotated for other polarizations.

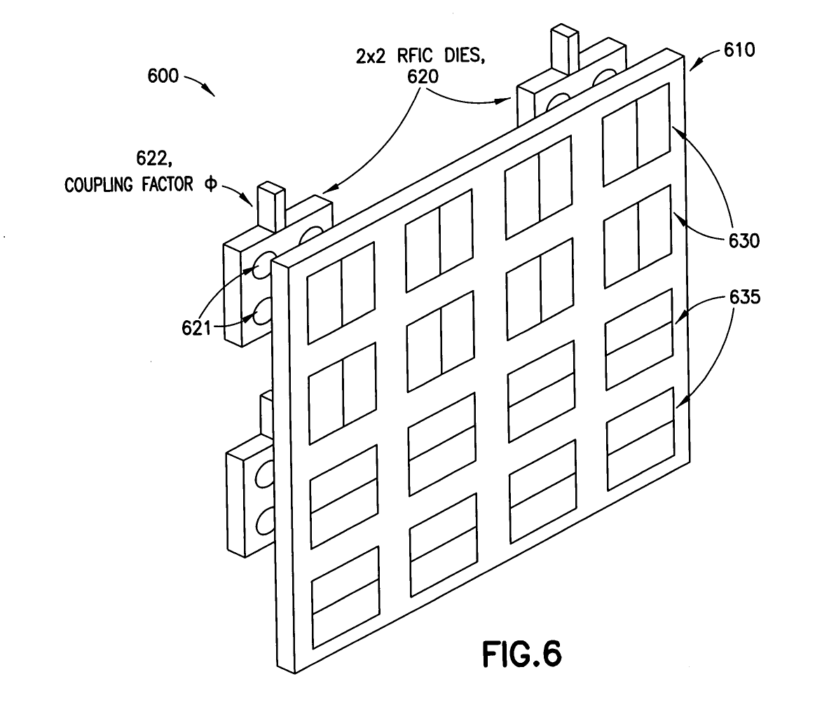

FIG. 6 illustrates a radio frequency integrated circuit (RFIC) structure 600 in accordance with an exemplary embodiment. The RFIC structure 600 includes a substrate 610 where a plurality of RFIC dies/antenna arrays 620 is attached. Each RFIC die 620 includes a number of individual antenna 621 (such as 4 antenna 621 in a 2×2 array for example). Each RFIC die 620 is provided a coupling factor, φ, 622 which is then applied to all antenna 621 in the RFIC die 620. The plurality of RFIC dies 620 may be divided into various sets. As a non-limiting example, a first set of antennas 630 has vertical polarity and a second set of antennas 635 has horizontal polarity. Additional sets may be generated, for example, multiple sets of antenna arrays having the same polarity and sets having different numbers of antenna arrays.

Since the carrier plates may be planer, the field of view of the array is limited. In order to achieve 360°, omni-directional coverage multiple arrays can be used to view particular segments of the field of view. In one non-limiting example, multiple arrays for both vertical and horizontal polarization may be used for each of four 90° quadrants.

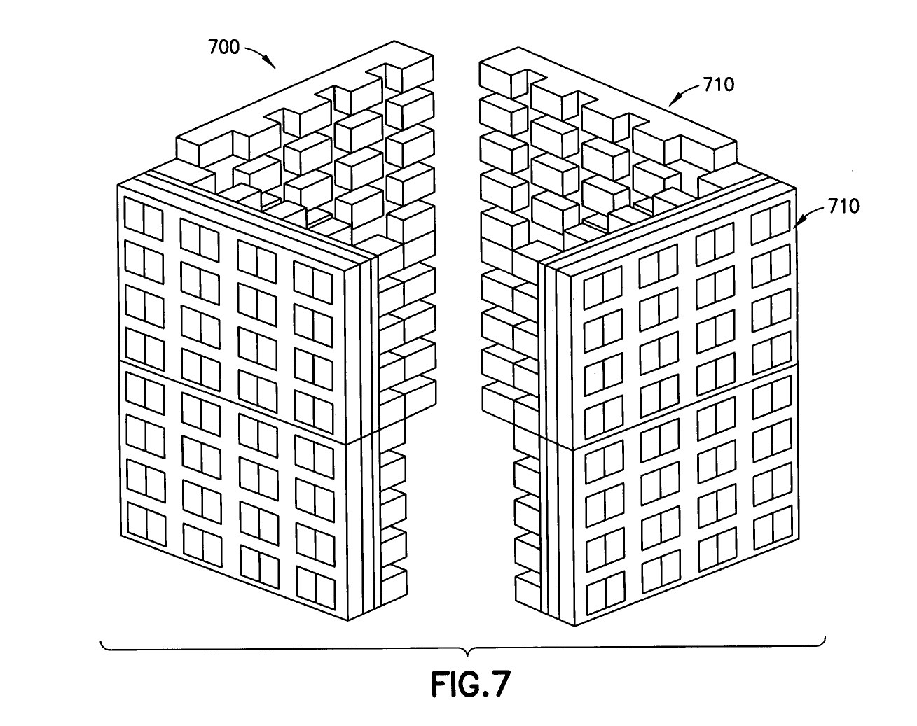

FIG. 7 illustrates an omni-directional coverage structure 700 in accordance with an exemplary embodiment. A plurality of RFIC structures 710 are placed so that all directions are within the coverage. For example, if each RFIC structures 710 provides an approximately 90° field of view, four RFIC structures 710 can be placed to provide a full 360° field of view. In a non-limiting embodiment, each RFIC structures 710 may provide a greater than 90° field of view so that the RFIC structures 710 may be located in way that provides partially overlapping fields of view between neighboring RFIC structures 710. This may be done to ensure a full 360° field of view and/or to provide additional coverage for less sensitive angles in the field of view of the individual RFIC structures 710.

Beamforming with chip-level antennas may be used to ensure reliable communications at millimeter wave (MMW) frequency. An antenna chip/die may be integrated with multiple antenna elements (for example between 4 and 16 elements) in an antenna array with coupled oscillators. More elements with multiple chips can be formed into an array through die-to-die coupling. A single beam with very high directional beamforming gain may be achieved with the multiple-chip arrays.

Multiple beams can be formed with multiple sets of antenna chips, each of which forms one beam. Each set of antenna chips may have independent TX and RX chains. Depending on the communication network needs, either a single beam or multiple beams can be formed with the multiple-chip arrays. When the oscillators of all antenna chips are coupled together, a single beam is formed with a high beamforming gain. When it is desired, coupled oscillators can be used to form one beam in one set of antenna chips. Antenna chips between different sets may use de-coupled oscillators.

Various exemplary embodiments provide a method of splitting RFIC antenna elements into multiple sets so that each set of antenna elements has one independent oscillator coupling factor. Another exemplary embodiment provides a method to combine multiple RFIC antenna chips into a single set of antenna elements by grouping sets of TX/RX functions on small RFICs and using multiple of these RFICs to form a large array in which the LO phase is controlled by groups of TX/RX functions and then independently controlled at each antenna element. A further exemplary embodiment provides a method to dynamically switch single/multiple beams by controlling coupling factors on demand.

A single RFIC die can be integrated with multiple antenna arrays, such as 2×2 or 4×4 arrays for example. Higher numbers of antenna elements may be located on a single RFIC die but such dies tend to be more expensive.

Multiple antenna chips can form a larger phased array using oscillator coupling. The oscillator coupling ensures phase control of antenna transmission so that a single beam can be achieved with high directional gain.

Various exemplary embodiments provide controllable oscillator coupling between two (or more) sets of antenna chips. Each set of antenna chips can be either coupled with other sets of chips to collectively form a single large beam, or decoupled from other sets to form individual beams. The communication network has the capability to dynamically control the phase coupling to generate single transmission beam or multiple beams on demand. The transmission power can be either uniformly allocated or independently allocated over multiple beams.

Two sets of antenna chips may be used for a single beam. Oscillator coupling control is applied for the two antenna chip sets so that a single beam can be formed with the combined antenna array. Overall single beam performance is improved with the increased number of antenna elements.

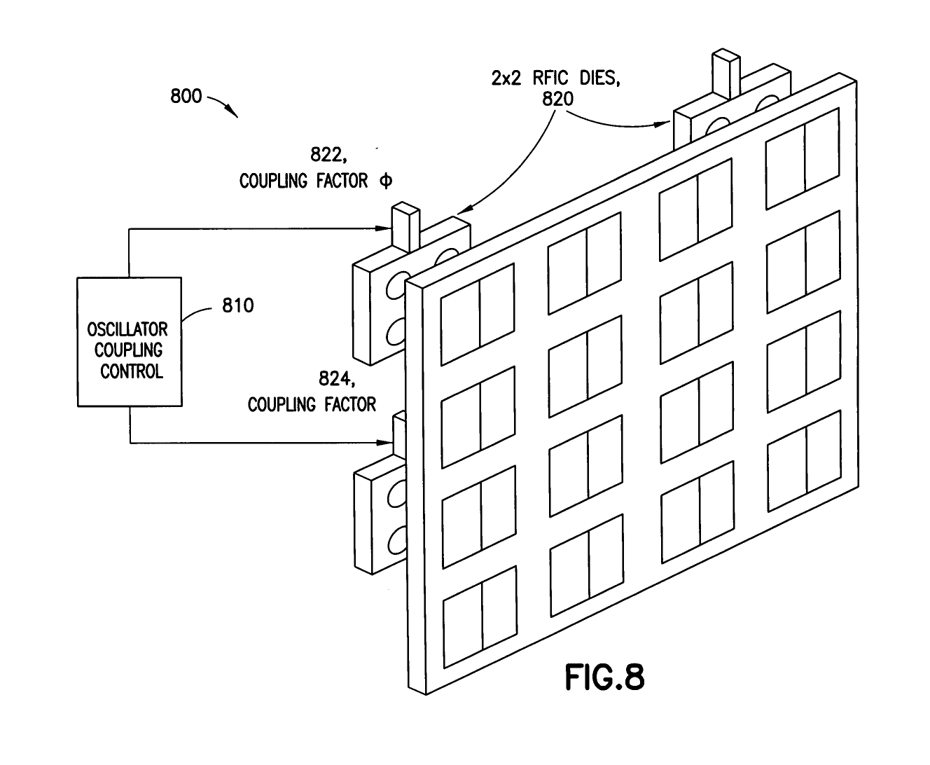

FIG. 8 illustrates another exemplary embodiment of a RFIC 800 in accordance with an exemplary embodiment. In this non-limiting example, the RFIC 800 includes an oscillator coupling control 810. The oscillator coupling control 810 provides a first coupling factor, φ, 822 to some RFIC dies 820 and a second coupling factor 824 to other RFIC dies 820. The first coupling factor 822 and the second coupling factor 824 may be the same so that all the RFIC dies 820 are coordinated to generate a single beam. Alternatively, the first coupling factor 822 and the second coupling factor 824 may be different so that multiple beams may be formed.

Accordingly, the oscillator coupling control 810 is configured to provide each RFIC die 820 an independent coupling factor 822, 824 which may (or may not) match the coupling factor 822, 824 provided to another RFIC die 820. Thus, the oscillator coupling control 810 can create various groups of RFIC dies 820 by providing each individual RFIC die 820 in the group with the same coupling factor 822, 824.

A dedicated structure to provide a single beam with similar performance to the RFIC 800 shown in FIG. 8 is more costly due to the dedicated use of the antenna chips. In contrast, in this non-limiting exemplary embodiment, the RFIC 800 may decouple the oscillators into two sets of antenna chips. Each set of antenna elements can have one independent coupling factor φ_{θ} for one direction at θ. This provides the network the flexibility to use the antenna chips to form a single beam when desired but also allows the network to form multiple beams rather than being forced to use all the antenna chips for one beam due the nature of the dedicated structure.

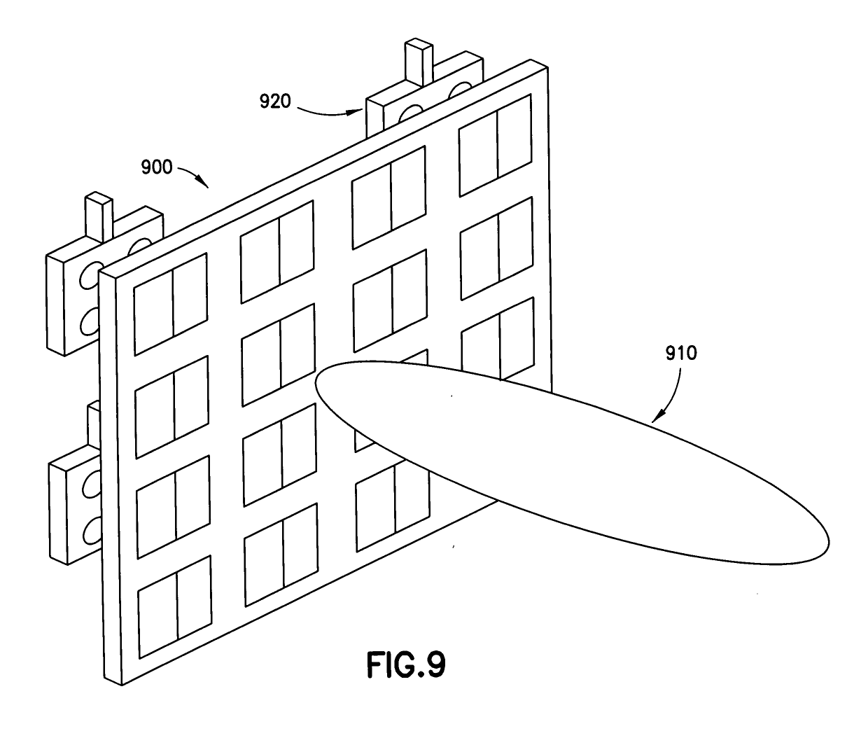

FIG. 9 shows an exemplary embodiment of a RFIC 900 being used for formation of a single beam 910. In order to generate the single beam 910 each of the RFIC dies 920 may be provided with the same coupling factor.

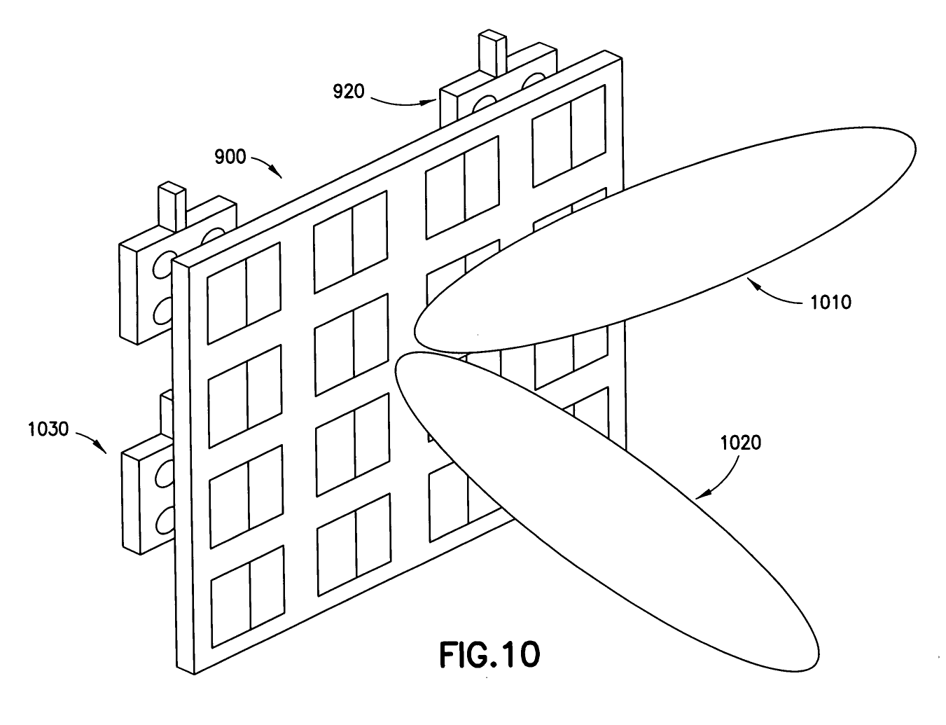

Using one coupling factor for all antenna elements forms a single beam out of the RFIC 800. If two coupling factors are used, as shown in FIG. 10, each decoupled set will form one beam. Thus, two sets of antenna chips will have two independent beams. The overall TX power may be shared with the two beams. The TX power and beamforming gain of each beam may be smaller than the single beam due to reduced number of antenna elements.

FIG. 10 shows another exemplary embodiment of the RFIC 900 of FIG. 9 being used for formation of two beams 1010, 1020. The various RFIC dies 920 may be separated into two groups and the individual RFIC dies 920, 1030 of the groups are then provided a group-specific coupling factor based on the group for the individual RFIC die 920, 1030. Thus, two different coupling factors would be used to generate the two beams 1010, 1020. For example, the RFIC die 920 and other RFIC dies in the first group that are provided with the first coupling factors may generate the first beam 1010, while the RFIC die 1030 and other RFIC dies in the second group that are provided with the second coupling factors may generate the second beam 1020. Each beam may be steered individually.

Using various exemplary embodiments, networks can schedule either single TX/RX beam or multiple TX/RX beams on demand. When there is a coverage issue for a cell-edge user, a single TX/RX beam at both the transmitter and receiver may be formed by applying a single oscillator coupling factor for all antenna elements for the individual beam. Both the TX and RX beam may use the same coupling factor. Beamforming gain is enhanced to ensure link quality performance.

When a user is close to the access point (or base station), multiple TX/RX beams at either transmitter or receiver side may be formed with multiple oscillator coupling factors (one oscillator coupling factor to each beam). Two beams may be formed with two independent coupling factors. One beam may be directed to the user and another beam may be directed either to another access point (such as for over-the-air backhaul transmission) or to another user (such as in MU-MIMO transmissions). The two beams may be separated spatially, so that there is insignificant interference between them. The spectral efficiency may be doubled with simultaneous transmission over two beams.

For a one-dimensional antenna array with M number of antenna elements, the directional beam with a given angle of arrival (AoA), θ, may be represented as:

$$y ( t ) = {\sum }_{m = 0}^{M - 1} {α}_{m} \text{?} s ( t - m \frac{D}{{f}_{c}} sin θ ) , \\ \text{?} \text{indicates text missing or illegible when filed}$$

where the phase coupling factor is φ=D sin θ, the normalized antenna spacing is D=d/λ, and f_{c} is the carrier frequency. The wavelength is λ.

Beam steering weights, αₘ, are applied to steer the beam shape towards direction θ, and s(t) is either the desired RX signal for a RX beam, or the transmit signal for a TX beam. One beam is formed with the M number of antenna elements. The phase coupling factor, φ, is coupled in the M-element antenna array to ensure the desired beamforming.

The antenna array with M-elements may be decoupled into multiple sets, under certain operation conditions in the network. For example, the M-elements may be separated to form two sets of antenna elements, each of which has M₁ and M₂ elements respectively. This gives the relationship: M=M₁₊M₂. A phase coupling factor, φ_{θ}, is applied for each set of elements. For this non-limiting example, the direction beam may be represented as:

$$y ( t ) = {\sum }_{m = 0}^{{M}_{1} - 1} {α}_{m} \text{?} {s}_{1} ( t - m \frac{D}{{f}_{c}} sin {θ}_{1} ) + {\sum }_{m = 0}^{{M}_{2} - 1} {α}_{m} \text{?} {s}_{2} ( t - m \frac{D}{\text{?}} sin {θ}_{2} ) , \\ \text{?} \text{indicates text missing or illegible when filed}$$

where the two beams have different AoA (θ₁ and θ₂) and are formed with M₁ and M₂-elements, respectively.

The splitting of M antenna elements into multiple sets may be applied to the LO distribution networks located on the common carrier substrate of the RFIC die. While conventional designs of the RFIC die use a single coupling factor, φ, to couple the phase of oscillators of antenna elements, various exemplary embodiments enable splitting the M antenna elements into multiple sets, each of with has an independent coupling factor φ_{θ} for an independent steering angle θ.

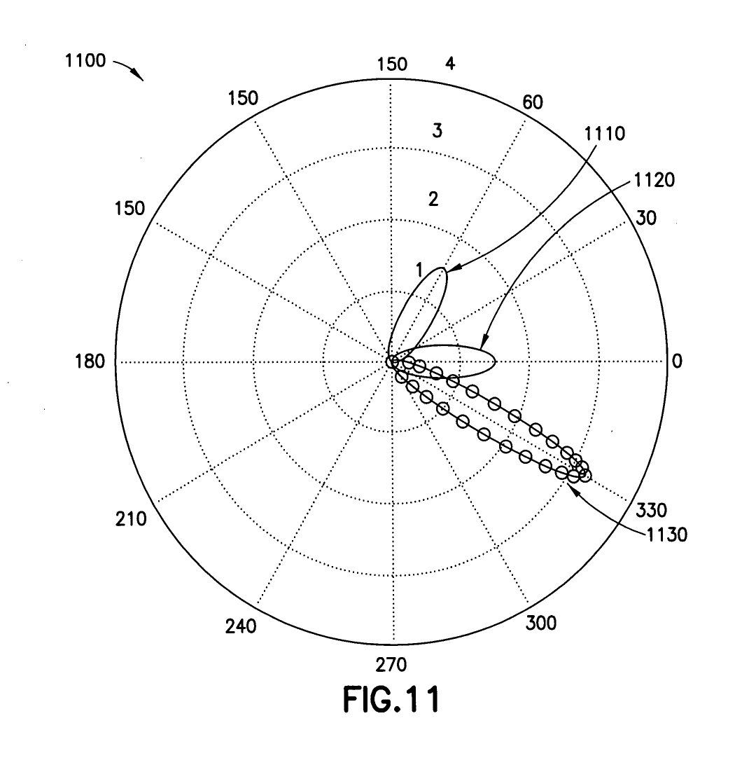

FIG. 11 displays a beam power/direction graph 1100 in accordance with an exemplary embodiment. The exemplary embodiment has 16 antenna elements. A first beam 1110 is formed (for example, by a first set of 8 antenna elements) in the 60° direction and has a power of approximately 1.5. A second beam 1120 is formed simultaneously (for example, by a second set of 8 antenna elements). This second beam 1120 faces in the 0° direction and also has a power of approximately 1.5.

At another time, the 16 antenna elements may be used to form a single beam 1130 in the 330° direction. This single beam 1130 has a power of approximately 3 (which is approximately equal to the combined power used for the first beam 1110 and the second beam 1120).

In one non-limiting embodiment, multiple beams are used to provide simultaneous over-the-air backhaul and access. Using two sets of antenna chips with controlled oscillator coupling a single base station may produce two independent TX/RX beams. To provide a backhaul, the network can control the two beams so that one beam is steered towards a backhaul node and the other beam is serving other users in the network. The backhaul node and the users in the serving cell may not be in the same direction which provides a minimum interference between the backhaul link and the DL/UL link. The backhaul and DL/UL transmission can be operated simultaneously. This enables a significant network capacity increase. Meanwhile, if there is a cell-edge user that can benefit from a higher beamforming gain, the network scheduler can couple the two sets of antenna chips to from a single beam to provide high directional gain since the scheduler can control the single/multiple beams dynamically.

In a further non-limiting embodiment, the multiple beams may be used to generate one transmit and one receive beam, allowing the eNB to act as a direct repeater to the over-the-air backhaul link. This may be used, for example, in a lightly loaded network where only eNBs with wire-line backhaul connection serve as access points while other eNBs act as repeaters for coverage improvement.

In another non-limiting embodiment, a use case similar to multi-user MIMO (MU-MIMO) transmission can be supported. If a user can receive transmissions which are sufficiently below the maximum allowed DL power for that user then multiple beams can be formed so that multiple DL links can be formed simultaneously. This provides an overall network capacity gain. Conversely, this method can be used for MU-MIMO reception on the UL as well. Multiple receive beams can be formed to allow multiple UEs to transmit at the same time to the eNB. A scheduling algorithm may be modified to consider total sum throughput and utility function optimization may be used for deciding whether to use multiple beams.

As discussed above, the eNB may provide multiple simultaneous DL links to a specific user. In such cases, the associated UE may also control oscillator coupling in order to produce two independent RX beams.

In a further non-limiting embodiment, the beams may be dynamically allocated on a symbol basis within an assignment slot (for example, fractional splitting). In some symbols, the eNB may form only one beam to a UE (such that the eNB concentrates power and beamforming gain to one UE) whereas in other symbols the eNB may form one beam to one UE and another beam to another UE (for example, to provide power and gain splitting). This allows UEs that are too far away and thus are beyond the coverage area of multiple beams to receive service simultaneously with other (closer) UEs.

While conventional techniques exist for MIMO transmissions such techniques do not provide control over which groups include various antenna elements. By enabling antenna elements to be combined into one or more groups, the eNB is provided a powerful tool to efficiently operate the antenna elements in order to meet changing service requirements. Additionally, exemplary embodiments enable utilizing multiple small, low cost RFICs to act as a composite array.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of the mmW system, it should be appreciated that the exemplary embodiments are not limited for use with only this one particular type of wireless communication system, and that they may be used to advantage in other wireless communication systems such as for example (E-UTRAN (UTRAN-LTE), WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

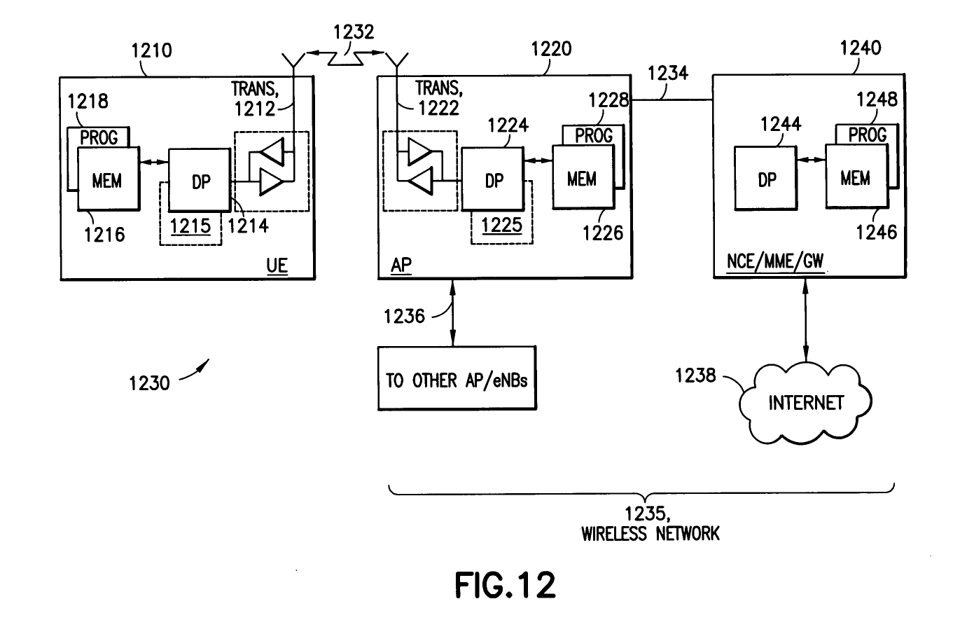

Reference is made to FIG. 12 for illustrating a simplified block diagram of various electronic devices and apparatus that are suitable for use in practicing exemplary embodiments.

In the wireless system 1230 of FIG. 12, a wireless network 1235 is adapted for communication over a wireless link 1232 with an apparatus, such as a mobile communication device which may be referred to as a UE 1210, via a network access node, such as a Node B (base station), and more specifically an access point (AP) 1220. The network 1235 may include a network control element (NCE) 1240 that may include MME/SGW functionality shown, and which provides connectivity with a network, such as a telephone network and/or a data communications network (e.g., the internet 1238).

The UE 1210 includes a controller, such as a computer or a data processor (DP) 1214, a computer-readable memory medium embodied as a memory (MEM) 1216 that stores a program of computer instructions (PROG) 1218, and a suitable wireless interface, such as radio frequency (RF) transceiver 1212, for bidirectional wireless communications with the AP 1220 via one or more antennas.

The AP 1220 also includes a controller, such as a computer or a data processor (DP) 1224, a computer-readable memory medium embodied as a memory (MEM) 1226 that stores a program of computer instructions (PROG) 1228, and a suitable wireless interface, such as RF transceiver 1222, for communication with the UE 1210 via one or more antennas. The AP 1220 is coupled via a data/control path 1234 to the NCE 1240. The path 1234 may be implemented as an S1 interface. The AP 1220 may also be coupled to another access points and/or to eNBs via data/control path 1236, which may be implemented as an X2 interface.

The NCE 1240 includes a controller, such as a computer or a data processor (DP) 1244, a computer-readable memory medium embodied as a memory (MEM) 1246 that stores a program of computer instructions (PROG) 1248.

At least one of the PROGs 1218, 1228 and 1248 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 1214 of the UE 1210; by the DP 1224 of the AP 1220; and/or by the DP 1244 of the NCE 1240, or by hardware, or by a combination of software and hardware (and firmware).

The UE 1210 and the AP 1220 may also include dedicated processors, for example antenna coupling controller 1215 and antenna coupling controller 1225.

In general, the various embodiments of the UE 1210 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 1216, 1226 and 1246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 1214, 1224 and 1244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 1212 and 1222) may be of any type suitable to the local technical environment and may be implemented using any suitable communication technology such as individual transmitters, receivers, transceivers or a combination of such components.

Further, the formulas and expressions that use these various parameters may differ from those expressly disclosed herein.

An exemplary embodiment provides a method for selectively performing beam formation using a RF chip-based antenna array. The method includes determining (such as by a processor for example) whether to use a plurality of antenna arrays in one or more common carrier substrates in either a single group or a plurality of groups. The method also includes, in response to determining to use the plurality of antenna arrays in a single group, providing (such as by a transmitter for example) a single coupling factor to all antenna arrays in the plurality of antenna arrays and, in response to determining to use the plurality of antenna arrays in a plurality of groups, providing (such as by a transmitter for example), for each group in the plurality of groups, a group-specific coupling factor to each antenna array in the group.

In a further exemplary embodiment of the method above, the antenna arrays are bidirectional antenna arrays.

In another exemplary embodiment of any one of the methods above, the antenna arrays are dual polarized.

In a further exemplary embodiment of any one of the methods above, the antenna arrays are single polarized and the method also includes rotating the antenna arrays.

In another exemplary embodiment of any one of the methods above, the plurality of groups includes three or more groups.

In a further exemplary embodiment of any one of the methods above, the method also includes determining an allowed transmission power for the plurality of antenna arrays; and allocating, to each group, a group-specific transmission power. A total of all the group-specific transmission powers is less than or equal to the allowed transmission power for the plurality of antenna arrays.

In another exemplary embodiment of any one of the methods above, the plurality of groups includes a first group and a second group. A beam from the first group is steered towards a backhaul node and a beam from the second group is steered towards a UE.

In a further exemplary embodiment of any one of the methods above, a determination to use the plurality of antenna arrays in a single group is made in response to serving a cell-edge UE.

In another exemplary embodiment of any one of the methods above, a determination to use the plurality of antenna arrays in a plurality of groups is made in response to serving at least one UE that is geographically close to the plurality of antenna arrays. The plurality of groups may provide a plurality of beams directed toward a single UE or a plurality of beams each directed towards a different UE.

In a further exemplary embodiment of any one of the methods above, determining whether to use a plurality of antenna arrays in a single group or a plurality of groups is based at least in part on a symbol-wise basis.

In another exemplary embodiment of any one of the methods above, determining whether to use a plurality of antenna arrays in a single group or a plurality of groups is based on the availability of multiple RFIC antenna chips in multiple common carrier substrates.

In a further exemplary embodiment of any one of the methods above, determining whether to use a plurality of antenna arrays in a single group or a plurality of groups is dynamically controlled by an AP. An allowed number of groups and directions of the groups may be controlled by the AP.

Another exemplary embodiment provides an apparatus for selectively performing beam formation using a RF chip-based antenna array. The apparatus includes at least one processor (such as DP 1224 for example) and at least one memory (such as MEM 1226 for example) storing computer program code (such as PROG 1228 for example). The at least one memory and the computer program code are configured to, with the at least one processor, cause the apparatus to perform actions. The actions include determining whether to use a plurality of antenna arrays in one or more common carrier substrates in either a single group or a plurality of groups. The actions also include, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group.

In a further exemplary embodiment of the apparatus above, the antenna arrays are bidirectional antenna arrays.

In another exemplary embodiment of any one of the apparatus above, the antenna arrays are dual polarized.

In a further exemplary embodiment of any one of the apparatus above, the antenna arrays are single polarized and the actions also include rotating the antenna arrays.

In another exemplary embodiment of any one of the apparatus above, the plurality of groups includes three or more groups.

In a further exemplary embodiment of any one of the apparatus above, the actions also include determining an allowed transmission power for the plurality of antenna arrays; and allocating, to each group, a group-specific transmission power. A total of all the group-specific transmission powers is less than or equal to the allowed transmission power for the plurality of antenna arrays.

In another exemplary embodiment of any one of the apparatus above, the plurality of groups includes a first group and a second group. A beam from the first group is steered towards a backhaul node and a beam from the second group is steered towards a UE.

In a further exemplary embodiment of any one of the apparatus above, a determination to use the plurality of antenna arrays in a single group is made in response to serving a cell-edge UE.

In another exemplary embodiment of any one of the apparatus above, a determination to use the plurality of antenna arrays in a plurality of groups is made in response to serving at least one UE that is geographically close to the plurality of antenna arrays. The plurality of groups may provide a plurality of beams directed toward a single UE or a plurality of beams each directed towards a different UE.

In a further exemplary embodiment of any one of the apparatus above, determining whether to use a plurality of antenna arrays in a single group or a plurality of groups is based at least in part on a symbol-wise basis.

In another exemplary embodiment of any one of the apparatus above, determining whether to use a plurality of antenna arrays in a single group or a plurality of groups is based on the availability of multiple RFIC antenna chips in multiple common carrier substrates.

In a further exemplary embodiment of any one of the apparatus above, determining whether to use a plurality of antenna arrays in a single group or a plurality of groups is dynamically controlled by an AP. An allowed number of groups and directions of the groups may be controlled by the AP.

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment provides a computer readable medium for selectively performing beam formation using a RF chip-based antenna array. The computer readable medium (such as MEM 1226 for example) is tangibly encoded with a computer program (such as PROG 1228 for example) executable by a processor (such as DP 1224 for example) to perform actions. The actions include determining whether to use a plurality of antenna arrays in one or more common carrier substrates in either a single group or a plurality of groups. The actions also include, in response to determining to use the plurality of antenna arrays in a single group, providing a single coupling factor to all antenna arrays in the plurality of antenna arrays and, in response to determining to use the plurality of antenna arrays in a plurality of groups, providing, for each group in the plurality of groups, a group-specific coupling factor to each antenna array in the group.

In a further exemplary embodiment of the computer readable medium above, the antenna arrays are bidirectional antenna arrays.

In another exemplary embodiment of any one of the computer readable media above, the antenna arrays are dual polarized.

In a further exemplary embodiment of any one of the computer readable media above, the antenna arrays are single polarized and the actions also include rotating the antenna arrays.

In another exemplary embodiment of any one of the computer readable media above, the plurality of groups includes three or more groups.

In a further exemplary embodiment of any one of the computer readable media above, the actions also include determining an allowed transmission power for the plurality of antenna arrays; and allocating, to each group, a group-specific transmission power. A total of all the group-specific transmission powers is less than or equal to the allowed transmission power for the plurality of antenna arrays.

In another exemplary embodiment of any one of the computer readable media above, the plurality of groups includes a first group and a second group. A beam from the first group is steered towards a backhaul node and a beam from the second group is steered towards a UE.

In a further exemplary embodiment of any one of the computer readable media above, a determination to use the plurality of antenna arrays in a single group is made in response to serving a cell-edge UE.

In another exemplary embodiment of any one of the computer readable media above, a determination to use the plurality of antenna arrays in a plurality of groups is made in response to serving at least one UE that is geographically close to the plurality of antenna arrays. The plurality of groups may provide a plurality of beams directed toward a single UE or a plurality of beams each directed towards a different UE.

In a further exemplary embodiment of any one of the computer readable media above, determining whether to use a plurality of antenna arrays in a single group or a plurality of groups is based at least in part on a symbol-wise basis.

In another exemplary embodiment of any one of the computer readable media above, determining whether to use a plurality of antenna arrays in a single group or a plurality of groups is based on the availability of multiple RFIC antenna chips in multiple common carrier substrates.

In a further exemplary embodiment of any one of the computer readable media above, determining whether to use a plurality of antenna arrays in a single group or a plurality of groups is dynamically controlled by an AP. An allowed number of groups and directions of the groups may be controlled by the AP.

In another exemplary embodiment of any one of the computer readable media above, the computer readable medium is a non-transitory computer readable medium (e.g., CD-ROM, RAM, flash memory, etc.).

In a further exemplary embodiment of any one of the computer readable media above, the computer readable medium is a storage medium.

Another exemplary embodiment provides an apparatus for selectively performing beam formation using a RF chip-based antenna array. The apparatus includes means for determining (such as a processor for example) whether to use a plurality of antenna arrays in one or more common carrier substrates in either a single group or a plurality of groups. The apparatus also includes means for providing (such as a transmitter for example) a single coupling factor to all antenna arrays in the plurality of antenna arrays in response to determining to use the plurality of antenna arrays in a single group, and means for providing (such as a transmitter for example), for each group in the plurality of groups, a group-specific coupling factor to each antenna array in the group in response to determining to use the plurality of antenna arrays in a plurality of groups.

In a further exemplary embodiment of the apparatus above, the antenna arrays are bidirectional antenna arrays.

In another exemplary embodiment of any one of the apparatus above, the antenna arrays are dual polarized.

In a further exemplary embodiment of any one of the apparatus above, the antenna arrays are single polarized and the apparatus also includes means for rotating the antenna arrays.

In another exemplary embodiment of any one of the apparatus above, the plurality of groups includes three or more groups.

In a further exemplary embodiment of any one of the apparatus above, the apparatus also includes means for determining an allowed transmission power for the plurality of antenna arrays; and means for allocating, to each group, a group-specific transmission power. A total of all the group-specific transmission powers is less than or equal to the allowed transmission power for the plurality of antenna arrays.

In another exemplary embodiment of any one of the apparatus above, the plurality of groups includes a first group and a second group. A beam from the first group is steered towards a backhaul node and a beam from the second group is steered towards a UE.

In a further exemplary embodiment of any one of the apparatus above, a determination to use the plurality of antenna arrays in a single group is made in response to serving a cell-edge UE.

In another exemplary embodiment of any one of the apparatus above, a determination to use the plurality of antenna arrays in a plurality of groups is made in response to serving at least one UE that is geographically close to the plurality of antenna arrays. The plurality of groups may provide a plurality of beams directed toward a single UE or a plurality of beams each directed towards a different UE.

In a further exemplary embodiment of any one of the apparatus above, determining whether to use a plurality of antenna arrays in a single group or a plurality of groups is based at least in part on a symbol-wise basis.

In another exemplary embodiment of any one of the apparatus above, determining whether to use a plurality of antenna arrays in a single group or a plurality of groups is based on the availability of multiple RFIC antenna chips in multiple common carrier substrates.

In a further exemplary embodiment of any one of the apparatus above, determining whether to use a plurality of antenna arrays in a single group or a plurality of groups is dynamically controlled by an AP. An allowed number of groups and directions of the groups may be controlled by the AP.

In another exemplary embodiment of any one of the apparatus above, the apparatus is embodied in a mobile device.

In a further exemplary embodiment of any one of the apparatus above, the apparatus is embodied in an integrated circuit.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

The following abbreviations that may be found in the specification and/or the drawing figures are defined as follows:
ADC analog/digital converter
AoA angle of arrival
AP access point, such as an eNB, relay node, etc.
BS basestation
BW bandwidth
CC component carrier
DAC digital/analog converter
DL downlink (eNB towards UE)
eNB E-UTRAN Node B (evolved Node B)
E-UTRAN evolved UTRAN (LTE)
FDD frequency division duplex
HTCC high temperature co-fired ceramic
IC integrated circuit
IF intermediate frequency
IMT-A international mobile telephony-advanced
ITU international telecommunication union
ITU-R ITU radiocommunication sector
LO local oscillator
LTCC low temperature co-fired ceramic
LTE long term evolution of UTRAN (E-UTRAN)
MIMO multi-input multi-output
MM/MME mobility management/mobility management entity
MMW millimeter wave
MU-MIMO multi-user MIMO
Node B base station
RF radio frequency
RFIC radio frequency integrated circuits
RX receive/receiver
S-GW serving gateway
TDD time division duplex
TX transmit/transmitter
UE user equipment, such as a mobile station or mobile terminal
UL uplink (UE towards eNB)
UTRAN universal terrestrial radio access network

What is claimed is:

1. A method comprising:
determining whether to use a plurality of antenna arrays in at least one common carrier substrate in one of: a single group and a plurality of groups;
in response to determining to use the plurality of antenna arrays in a single group, providing a single coupling factor to all antenna arrays in the plurality of antenna arrays; and
in response to determining to use the plurality of antenna arrays in a plurality of groups, providing, for each group in the plurality of groups, a group-specific coupling factor to each antenna array in the group.

2. The method of claim 1, where the antenna arrays are bidirectional antenna arrays.

3. The method of claim 1, where the antenna arrays are dual polarized.

4. The method of claim 1, where the antenna arrays are single polarized and the method further comprises rotating the antenna arrays.

5. The method of claim 1, where the plurality of groups comprises three or more groups.

6. The method of claim 1, further comprising determining an allowed transmission power for the plurality of antenna arrays; and
allocating, to each group, a group-specific transmission power,
where a total of all the group-specific transmission powers is less than or equal to the allowed transmission power for the plurality of antenna arrays.

7. The method of claim 1, where the plurality of groups comprises a first group and a second group,
where a beam from the first group is steered towards a backhaul node and
where a beam from the second group is steered towards a user equipment.

8. The method of claim 1, where a determination to use the plurality of antenna arrays in a single group is made in response to serving a cell-edge user equipment.

9. The method of claim 1, where a determination to use the plurality of antenna arrays in a plurality of groups is made in response to serving at least one user equipment that is geographically close to the plurality of antenna arrays.

10. The method of claim 9, where the plurality of groups provide at least one of:
a plurality of beams directed toward a single user equipment and
a plurality of beams each directed towards a different user equipment.

11. The method of claim 1, where determining whether to use a plurality of antenna arrays in one of a single group and a plurality of groups is based at least in part on a symbol-wise basis.

12. The method of claim 1, where determining whether to use a plurality of antenna arrays in one of a single group and a plurality of groups is based on the availability of multiple radio frequency integrated circuit antenna chips in multiple common carrier substrates.

13. The method of claim 1, where determining whether to use a plurality of antenna arrays in one of a single group and a plurality of groups is dynamically controlled by an access point.

14. The method of claim 13, where an allowed number of groups and directions of the groups are controlled by the access point.

15. An apparatus, comprising at least one processor; and at least one memory including computer program code, the at least one memory and the computer program code configured to, with the at least one processor, cause the apparatus to perform at least the following:
to determine whether to use a plurality of antenna arrays in at least one common carrier substrate in one of: a single group and a plurality of groups;
in response to determining to use the plurality of antenna arrays in a single group, to provide a single coupling factor to all antenna arrays in the plurality of antenna arrays; and
in response to determining to use the plurality of antenna arrays in a plurality of groups, to provide, for each group in the plurality of groups, a group-specific coupling factor to each antenna array in the group.

16. The apparatus of claim 15, where a determination to use the plurality of antenna arrays in a single group is made in response to serving a cell-edge user equipment.

17. The apparatus of claim 15, where a determination to use the plurality of antenna arrays in a plurality of groups is made in response to serving at least one user equipment that is geographically close to the plurality of antenna arrays.

18. A computer readable medium tangibly encoded with a computer program executable by a processor to perform actions comprising:
determining whether to use a plurality of antenna arrays in at least one common carrier substrate in one of: a single group and a plurality of groups;
in response to determining to use the plurality of antenna arrays in a single group, providing a single coupling factor to all antenna arrays in the plurality of antenna arrays; and
in response to determining to use the plurality of antenna arrays in a plurality of groups, providing, for each group in the plurality of groups, a group-specific coupling factor to each antenna array in the group.

19. The computer readable medium of claim 18, where a determination to use the plurality of antenna arrays in a single group is made in response to serving a cell-edge user equipment.

20. The computer readable medium of claim 18, where a determination to use the plurality of antenna arrays in a plurality of groups is made in response to serving at least one user equipment that is geographically close to the plurality of antenna arrays.
